(19) United States
(12) Patent Application Publication
(10) Pub. No.: US 2024/0189791 A1
(43) Pub. Date: Jun. 13, 2024

(54) PHOTOCATALYTIC APPARATUS

(71) Applicants: THE UNIVERSITY OF ADELAIDE, South Australia (AU); FLINDERS UNIVERSITY, South Australia (AU)

(72) Inventors: Gregory METHA, Stirling, South Australia (AU); Jason ALVINO, Athelstone, South Australia (AU); Gunther ANDERSSON, McLaren Vale, South Australia (AU); D.J. OSBORN, Eden Hills, South Australia (AU)

(21) Appl. No.: 18/553,343

(22) PCT Filed: Apr. 5, 2022
(86) PCT No.: PCT/AU2022/050300

§ 371 Date: Sep. 29, 2023

(30) Foreign Application Priority Data
Apr. 6, 2021 (AU) 2021900997

(51) Int. Cl. B01J 8/02; C01B 3/04

(52) U.S. Cl. CPC B01J 8/0278; B01J 8/0285; C01B 3/042; B01J 2208/00212

(57) ABSTRACT

This disclosure relates to an apparatus and a method for photocatalytically splitting H2O, that is either in liquid or gaseous form, to produce hydrogen and oxygen using a radiation source comprising a spectrum of both a high energy component (such as ultraviolet, or UV, comprising visible light) and a low energy component (such as infrared, or IR, also comprising visible light). That is to say, the apparatus and the method both utilise or involve the entire or full spectrum of the radiation source to split H2O. Both the apparatus and method utilise a radiation concentrator assembly that comprises at least one optical element arranged and constructed to direct radiation from the radiation source on to a photocatalyst via a window to photocatalytically split H2O. The produced hydrogen and oxygen may subsequently be stored and used as a fuel source.

### CROSS-REFERENCE TO RELATED APPLICATIONS

The present application is a U.S. a national stage application under 35 U.S.C. § 371 of International Patent Application No. PCT/AU2022/050300 titled “PHOTOCATALYTIC APPARATUS” and filed on 5 Apr. 2022, which claims priority from Australian Provisional Patent Application No. 2021900997 titled “PHOTOCATALYTIC APPARATUS” and filed on 6 Apr. 2021, the content of each of which is hereby incorporated by reference in its entirety.

### TECHNICAL FIELD

The present disclosure relates to the field of hydrogen production using a photocatalyst. In a particular embodiment the present disclosure relates to an apparatus and a method for producing hydrogen by photocatalytically splitting H2O using a radiation source.

### BACKGROUND

At present, approximately 90% of global energy (such as industrial energy and transportation energy) is derived from fossil fuel energy sources, as they have presented economic affordability and availability to economies. However, with increasing energy demand, population growth and growing environmental concern, global economies have recognised the depleting fossil fuel energy sources and the need for change to renewable sources of energy to replace the current need for fossil fuels.

The focus of many researchers and innovators has been to design alternate methods for energy production (such as hydropower, wind power, geothermal and solar power), however some of these alternative methods often have many practical limitations which reduce their efficiency and applicability (such as high costs associated with development, maintenance and storage of energy produced).

Solar energy as an alternative energy source is often considered as the most promising candidate to replace fossil fuels. The use of solar energy to split water (H2O) photocatalytically is a promising and simple strategy to produce hydrogen for use as a fuel, in a clean and storable manner. In presently available photocatalytic H2O splitting technologies, the hydrogen (H2) and oxygen (O2) evolution reactions take place over a photocatalyst and the H2 fuel is captured or stored at an outlet. However, these existing technologies suffer in terms of scalability as well as low solar to hydrogen (STH) output due to the low energy density of sunlight. Thus, there is a need to provide an apparatus and a method that enables the use of solar energy to photocatalytically split H2O that overcomes the above-mentioned challenges associated therewith.

It is against this background and the problems and difficulties associated therewith, that the present invention has been developed.

### SUMMARY

Embodiments of the present disclosure relate to an apparatus and method for photocatalytically splitting H2O that is in either liquid or gaseous form, to produce hydrogen and oxygen using a radiation source comprising a spectrum comprising both a high energy component and a low energy component.

According to a first aspect of the present disclosure, there is provided an apparatus for photocatalytically splitting H2O using a radiation source, the apparatus comprising a reaction vessel for receiving H2O to be split photocatalytically and a radiation concentrator assembly; wherein the reaction vessel comprises: a window for receiving radiation from the radiation source into the reaction vessel, an inlet for receiving H2O into the reaction vessel, a photocatalyst positioned within the reaction vessel comprising radiation absorbing particles such that, in use, the radiation absorbing particles absorb radiation and photocatalytically split the H2O into hydrogen and oxygen; an outlet for discharging the hydrogen and oxygen from the reaction vessel; and wherein the radiation concentrator assembly comprises: at least one optical element arranged and constructed to direct radiation onto the window.

In one embodiment, the window is elongate and the direction of elongation is perpendicular to a flow path of the H2O from the inlet to the outlet.

In one embodiment, a length of elongation of the window is greater than a length from the inlet to the outlet.

In one embodiment, the photocatalyst is elongate in the same direction as the elongate window, and the radiation concentrator assembly extends in a longitudinal direction parallel to the elongate direction of the window and perpendicular to the H2O flow path.

In one embodiment, the H2O and photocatalytically split hydrogen and oxygen is separated from the window by the photocatalyst.

In one embodiment, in use, the H2O is directed through the reaction vessel such that the photocatalytically split hydrogen and oxygen does not impede the radiation absorbed by the photocatalyst via the window.

In one embodiment, the window is located on an underside of the reaction vessel, and at least one optical element is arranged to direct radiation onto the window from the underside of the reaction vessel.

In one embodiment, the reaction vessel further comprises a channel between the window and the photocatalyst, wherein the channel is sized and shaped so as to contain H2O between the window and the photocatalyst.

In one embodiment, a thickness of the channel is less than 1 mm between the window and the photocatalyst. In an alternative embodiment, a thickness of the channel is greater than 1 mm between the window and the photocatalyst.

In one embodiment, the window comprises an external surface that is coated with an infrared (IR) reflective. In another embodiment, the window comprises the external surface that is coated with an upconversion coating.

In one embodiment, the upconversion coating acts so as to convert long-wavelengths from the directed radiation into short-wavelengths, and wherein the infrared (IR) reflective coating acts so as to reduce a temperature within the reaction vessel.

In one embodiment, the reaction vessel further comprises one or more fins extending outwardly from a rear or a side of the reaction vessel, wherein in use, the one or more fins and the infrared (IR) reflective coating act so as to reduce a temperature within the reaction vessel.

In one embodiment, the radiation source is one or more of solar radiation, thermal radiation or electromagnetic radiation.

In one embodiment, the radiation source comprises a spectrum comprising both a high energy component and a low energy component.

In one embodiment, the high energy component is an ultraviolet (UV) component comprising visible light, and the low energy component is an infrared (IR) component comprising visible light.

In one embodiment, the radiation source is solar radiation and the spectrum comprises the entire solar spectrum of both an ultraviolet (UV) component comprising visible light and an infrared (IR) component comprising visible light.

In one embodiment, the window is constructed to receive radiation from the radiation source comprising the spectrum of both the high energy component and the low energy component into the reaction vessel.

In one embodiment, in use, the radiation absorbing particles absorb the high energy component of the spectrum for photocatalytically splitting H2O.

In one embodiment, in use, the low energy component of the spectrum increases the temperature of the H2O being photocatalytically split.

In one embodiment, in use, the low energy component of the spectrum increases a rate at which the H2O is photocatalytically split by the radiation absorbing particles.

In one embodiment, the radiation concentrator assembly comprises a plurality of optical elements, wherein each of the optical elements comprise one or more reflectors for reflecting and concentrating radiation from the radiation source. In an alternative embodiment, the radiation concentrator assembly comprises a plurality of optical elements, wherein each of the optical elements comprise one or more refractors to refract and concentrate radiation from the radiation source.

In one embodiment, the one or more reflectors reflect and concentrate both the high energy and low energy components of the radiation source. In an alternative embodiment, the one or more refractors refract and concentrate both the high energy and low energy components of the radiation source.

In one embodiment, the one or more refractors are one or more converging lenses.

In one embodiment, the optical elements are Linear Fresnel Reflectors (LFRs).

In one embodiment, the window is elongate and the LFRs direct a linear beam of radiation from the radiation source along an elongate length of the window.

In one embodiment, the optical elements are parabolic troughs, and wherein the window is elongate and the parabolic trough comprise a concave shape for directing a linear beam of radiation from the radiation source along an elongate length of the window.

In one embodiment, the optical elements are positionable and adjustable so as to track the radiation source, and wherein in use, the optical elements of the radiation concentrator assembly are positioned and adjusted so as to maximize radiation of the radiation source and the spectrum comprising both high energy and low energy components directed onto the window.

In one embodiment, the radiation source is the sun.

In one embodiment, the radiation concentrator assembly reflects and concentrates radiation from the sun such that the window receives the full solar spectrum of both high energy and low energy components to photocatalytically split H2O within the reaction vessel.

In one embodiment, the radiation concentrator assembly, in use, amplifies the radiation from the sun such that the reflected spectrum received by the window comprises both high energy and low energy components greater than that of one sun.

In one embodiment, the apparatus further comprises a separator for separating hydrogen from oxygen.

In one embodiment, the separator is in fluid communication with the outlet of the reaction vessel.

In one embodiment, the H2O is in either a liquid or gas phase, or both.

In one embodiment, the radiation absorbing particles comprise one or more of micro-particles, nano-particles or pico-particles capable of absorbing radiation to photocatalytically split H2O.

In one embodiment, the radiation absorbing particles is a semiconductor.

In one embodiment, the radiation absorbing particles is a radiation absorbing material.

In one embodiment, the reaction vessel is enclosed by a jacket, wherein the jacket comprises one or more injection ports and one or more corresponding ejection ports so as to enable a cooling fluid to flow through the jacket to cool the reaction vessel, wherein in use, the cooling fluid is heated by the reaction vessel and is directed downstream of the one or more ejection ports for use as a heated fluid by-product.

In one embodiment, the reaction vessel is pressurised.

According to a second aspect of the present disclosure, there is provided an apparatus for photocatalytically splitting H2O using a radiation source, the apparatus comprising a reaction vessel for receiving H2O to be split photocatalytically and a radiation concentrator assembly: wherein the reaction vessel comprises: a window for receiving radiation from the radiation source, wherein the window is located on an underside of the reaction vessel; an inlet for receiving H2O into the reaction vessel; a photocatalyst positioned within the reaction vessel comprising radiation absorbing particles such that, in use, the radiation absorbing particles absorb radiation and photocatalytically split the H2O into hydrogen and oxygen; an outlet for discharging the hydrogen and oxygen from the reaction vessel; wherein the radiation concentrator assembly comprises: at least one optical element arranged and constructed to direct radiation onto the window; and wherein, in use. H2O is directed through the reaction vessel such that the photocatalytically split hydrogen and oxygen does not impede the radiation absorbed by the photocatalyst via the window.

According to an additional aspect of the present disclosure, there is provided an apparatus for photocatalytically splitting H2O using a radiation source, the apparatus comprising a reaction vessel and a radiation concentrator assembly: wherein the reaction vessel comprises: an inlet for receiving H2O into the reaction vessel; a photocatalyst positioned within the reaction vessel comprising radiation absorbing particles such that, in use, the radiation absorbing particles absorb radiation and photocatalytically split the H2O into hydrogen and oxygen; an outlet for discharging the hydrogen and oxygen from the reaction vessel; a window that is elongate in a direction perpendicular to a flow path of the H2O from the inlet to the outlet, wherein the elongate window receives radiation from the radiation source and into the reaction vessel; and wherein the radiation concentrator assembly extends in a longitudinal direction parallel to the elongate direction of the window and comprises: at least one optical element arranged and constructed to direct radiation onto the elongate window.

According to a second aspect of the present disclosure, there is provided a method for photocatalytically splitting H2O using a radiation source, the method comprising the steps of: (a) flowing H2O through an inlet of a reaction vessel comprising a photocatalyst comprising radiation absorbing particles positioned within the reaction vessel; (b) using a radiation concentrator assembly to concentrate radiation comprising a spectrum comprising a high energy component and a low energy component from the radiation source and directing the concentrated radiation onto an elongate window extending in a direction perpendicular to a flow path of the H2O in the reaction vessel; (c) exposing both the H2O and the photocatalyst to the concentrated radiation through the elongate window, such that the radiation absorbing particles absorb the high energy component of the spectrum to photocatalytically split the H2O into hydrogen and oxygen, and the low energy component of the spectrum increases the temperature of the H2O within the reaction vessel; and (d) discharging the resultant hydrogen and oxygen via the outlet of the reaction vessel.

In one embodiment, the discharged hydrogen and oxygen at the outlet are subsequently separated in a separator in fluid communication with the outlet.

In one embodiment, the radiation source is the sun, the radiation is solar irradiation and the spectrum is the solar spectrum.

In one embodiment, the high energy component is ultraviolet (UV) comprising visible light and the low energy component is infrared (IR) comprising visible light.

In one embodiment, the radiation concentrator assembly, in use, amplifies the solar irradiation from the sun such that the reflected spectrum received by the window comprises both high energy and low energy components greater than that of one sun.

According to an additional aspect of the present disclosure, there is provided a method for producing hydrogen and oxygen, comprising photocatalytically splitting H2O using a photocatalyst comprising radiation absorbing particles contained within a reaction vessel, and concentrating a radiation source using a radiation concentrator assembly onto both the photocatalyst and H2O so as to utilise both high energy and low energy components emitted from the radiation source in the photocatalytic reaction.

According to a further aspect of the present disclosure, there is provided a method for producing hydrogen and oxygen from H2O, the method comprising flowing H2O through a reaction vessel comprising a photocatalyst of radiation absorbing particles, and using a radiation concentrator assembly to concentrate radiation comprising a spectrum of both high energy and low energy components from a source onto a window of the reaction vessel and thus the photocatalyst and H2O, wherein the radiation absorbing particles absorb the high energy component of the spectrum to photocatalytically split H2O into hydrogen and oxygen and the low energy component of the spectrum increases the temperature of the H2O within the reaction vessel.

In one embodiment, the H2O is dirty water such as waste water or water by-products of other processes.

In one embodiment, the H2O is distilled, and therefore purified, to be in a gaseous phase by the increased temperature due to the low energy component of the spectrum.

### BRIEF DESCRIPTION OF DRAWINGS

Embodiments of the present disclosure will be discussed with reference to the accompanying drawings wherein:

FIG. 1 is a schematic perspective view of an apparatus for photocatalytically splitting H2O using a radiation source;

FIG. 2 is a schematic perspective view of a plurality of cooling fins;

FIG. 3 is a side view of a pressure regulator and a eudiometer for use with the apparatus of FIGS. 1 and 2;

FIG. 4 is an alternative schematic perspective view of the apparatus of FIG. 1 illustrating an apparatus and a direction a reaction vessel extends relative to directed radiation from a source;

FIG. 5 is an example of a plurality of the apparatus's of FIGS. 1 to 4 in use with a plurality of Linear Fresnel Reflector Systems connected to a H2O source;

FIG. 6 is a graphic illustrating spectral parts (i.e. components) of the solar spectrum which may be used as the radiation source for the apparatus of any one of the above Figures;

FIG. 7 is a graphic illustrating H2 (gas) production rates at increasing temperatures using the apparatus of any one of FIGS. 1 and 4;

FIG. 8 is a graphic illustrating H2 and O2 evolution rates at increasing temperatures using the apparatus of any one of FIGS. 1 and 4;

FIG. 9 is a graphic illustrating H2 gas evolution rates at increasing temperatures following the Arrhenius Relationship, assuming a linear relationship exists;

FIG. 10 is an alternative embodiment of the apparatus, in which the apparatus includes a window disposed on an underside of a reaction vessel;

FIG. 11 is a sectional view of the apparatus along lines A-A of FIG. 1;

FIG. 12 is a graphic illustrating a response of a photocatalyst (of any one of the above Figures) is linear with respect to increased radiation from the radiation source;

FIG. 13A is a schematic illustrating a receiver assembly comprising a pair of apparatus of FIG. 10, such that each apparatus is at an angle to a horizontal on which a radiation concentrator assembly comprising a plurality of optical elements is arranged;

FIG. 13B is a schematic illustration, in detail, of the receiver of FIG. 13A; and

FIG. 14 is a graphic illustrating H2 gas evolution rates against photon flux measured in units of time, using the apparatus of any one of FIGS. 1 and 4.

In the following description, like reference characters designate like or corresponding parts throughout the figures.

### DESCRIPTION OF EMBODIMENTS

Referring to any one of the Figures, there is disclosed an apparatus and a method for photocatalytically splitting water (hereinafter interchangeably referred to as “H2O”), that is in either liquid or gaseous form, to produce hydrogen (hereinafter interchangeably referred to as “H2”) and oxygen (hereinafter interchangeably referred to as “O2”) using a radiation source comprising a spectrum of both a high energy component (such as ultraviolet, or UV, comprising visible light) and a low energy component (such as infrared, or IR, also comprising visible light). It will be apparent from the disclosure below, that H2 and O2 produced may be considered chemical fuels that may be subsequently stored or used for energy production methods. It will also be apparent that in any one of the embodiments of the disclosure below that the apparatus and method for photocatalytically splitting water utilises or involves the entire or full spectrum of the radiation source. It will further be apparent that in any one of the embodiments of the disclosure below, that the apparatus and method are particularly applicable to continuously photocatalytically spit water to produce hydrogen and oxygen that may be utilised as chemical fuels.

Particularly, the present disclosure relates to an apparatus (100) for photocatalytically splitting H2O using a radiation source (200). The apparatus (100) comprises a reaction vessel (10) for receiving H2O to be split photocatalytically and a radiation concentrator assembly (20).

Additionally, the present disclosure also relates to a method for producing H2 by photocatalytically splitting H2O using a photocatalyst (11) comprising radiation absorbing particles contained within the reaction vessel (10), and concentrating the radiation source (200) using the radiation concentrator assembly (20) onto both the photocatalyst (11) and H2O so as to utilise both high energy and low energy components emitted from the radiation source in the photocatalytic reaction.

Furthermore, the high energy component of the spectrum of the radiation source discussed herein, may alternatively be considered a photon excitation component and comprise at least partially visible light within the spectrum. In this way, the high energy component of the spectrum is utilised by the photocatalyst (11) to excite photons such that the H2O is photocatalytically split. Similarly, the low energy component of the spectrum of the radiation source discussed herein, may also comprise at least partially visible light within the spectrum to increase the temperature within the reaction vessel (10). Thus, it may be assumed that the high and low energy components of the spectrum may overlap as they both, at least partially, comprise visible light within the spectrum.

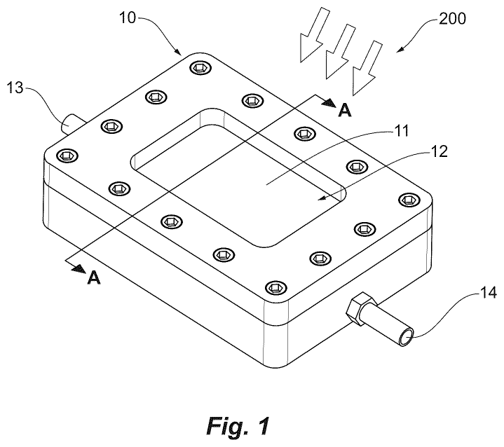

Referring to any one of FIGS. 1 to 5, 10 and 11, in one embodiment, the reaction vessel (10) comprises a window (12) for receiving radiation from the radiation source (200) into the reaction vessel (10), an inlet (13) for receiving H2O into the reaction vessel (10), the photocatalyst (11) being positioned within the reaction vessel (10), and an outlet (14) for discharging the H2 and O2 from the reaction vessel (10). In use, the radiation absorbing particles of the photocatalyst (11) absorb radiation and photocatalytically split the H2O into H2 and O2. The radiation concentrator assembly (20) comprises at least one optical element (21) arranged and constructed to direct radiation onto the window (12) of the reaction vessel (10). In this embodiment, the photocatalyst (11) is a sheet and is fixed within the reaction vessel (10).

The radiation source (200) discussed herein may be one or more of solar radiation, thermal radiation or electromagnetic radiation. The radiation source (200) is intended to be selected such that the production of H2 and O2 from photocatalytically splitting H2O in a renewable manner, that is, to be a clean and environmentally friendly method of creating chemical fuels. The radiation source (200) is also selected such that it comprises the spectrum of both the high energy component and the low energy component. One of the ideal radiation sources (200) for either the apparatus (100) or the method in any one of the embodiments of this disclosure is solar radiation in which the spectrum comprises the entire solar spectrum of ultraviolet (UV) comprising, at least partially, visible light as the high energy component and infrared (IR) comprising, at least partially, visible light as the low energy component.

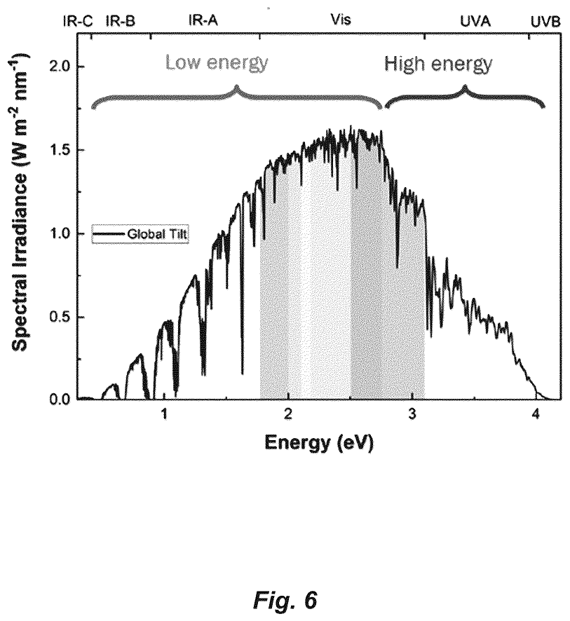

Utilising solar radiation as the radiation source (200) ensures that there is a renewable, clean and environmentally available source to photocatalytically spilt H2O to produce H2 and O2. Traditionally, only the UV (i.e. the high energy) component of the solar spectrum has been utilised for photocatalytically splitting H2O for H2 production. In these traditional technologies, harnessing only the UV component of the solar spectrum for photocatalytically splitting H2O is problematic, in that the UV component of the solar spectrum is only approximately 8% of the total solar spectrum. The low energy component (IR) of the solar spectrum, makes up for the majority of the spectrum and has traditionally not been utilised or has been problematic for existing technologies to produce H2 (e.g. IR radiation is not energetic enough to excite electrons across the bandgap of the semiconductor). FIG. 6 illustrates graphically the proportion of the solar spectrum that is UV and visible light (VIS), denoted as the section of the graph labelled ‘high energy’ and UVA/UVB along the upper x-axis, and IR (which is shown to at least partially comprise visible light VIS) denoted as the section of the graph labelled ‘low energy’ and IR-A/IR-B/IR-C along the upper x-axis. It is the intention of this disclosure to utilise the entire/total solar spectrum for photocatalytically splitting H2O, such that the high energy component (UV comprising visible light) photocatalytically splits H2O into H2 and O2, while the low energy component (IR, comprising at least partially visible light) increases the temperature of the H2O being photocatalytically split.

Referring now to any one of FIGS. 1 to 5, in one embodiment of the apparatus (100), the reaction vessel (10) comprises a channel (not shown) between the window (12) and the photocatalyst (11). The channel being sized and shaped so as to contain H2O between the window (12) and the photocatalyst (11). The channel spanning between the inlet (13) and outlet (14) of the reaction vessel (10), such that the H2O is directed from the inlet (13) to be exposed to the photocatalyst (11) whereby the radiation absorbing particles of the photocatalyst (11) photocatalytically split the H2O into H2 and O2, which is then directed toward the outlet (14).

In the above embodiment, the channel may comprise a thickness of less than 1 mm between the window (12) and the photocatalyst (11). In an alternative, the thickness between the window (12) and the photocatalyst (11) may be greater than 1 mm. That is to say, the channel is sized and shaped so as to contain H2O between the window (12) and the photocatalyst (11) where the H2O layer within the channel is thicker than 1 mm. In the alternative that the thickness of the channel is greater than 1 mm, the H2O layer within the channel will be heavier than in the embodiment that the channel is of a thickness less than 1 mm.

In one embodiment, alternate to the above, the reaction vessel (10) comprises a means that allows the H2O, and the subsequent hydrogen and oxygen photocatalytically split therefrom, to be separated from the window (12) and the photocatalyst (11). That is to say, in this alternate embodiment, the H2O is directed through the reaction vessel (10) from the inlet (13) to the outlet (14) such that the photocatalytically split hydrogen and oxygen does not impede the radiation absorbed by the photocatalyst (11) received via the window (12). It will be understood that in this alternate embodiment, the means physically separates the H2O, the photocatalytically split hydrogen and oxygen from obstructing/blocking/reflecting/reducing the directed radiation through the window (12) being received by the photocatalyst (11). An advantage of this alternate embodiment lies in that by physically separating the H2O, hydrogen and oxygen via the means from impeding the directed radiation reaching the photocatalyst (11), the reaction vessel (10) in use advantageously achieves a higher hydrogen and oxygen yield at the outlet (14).

Additionally, in this alternate embodiment, it will be appreciated that the window (12) and photocatalyst (11) both preferably employ a flat design, shape or configuration. Whereby the flat design, shape or configuration of the window (12) and photocatalyst (11) more readily enables the reaction vessel (10) to have the means to physically separate the H2O, hydrogen and water from impeding the directed radiation reaching the photocatalyst (11).

Furthermore, it will be understood that the H2O, hydrogen and oxygen may be in a liquid, vapour or gaseous state, and that the means is capable of physically separating any one of these states from impeding the directed radiation reaching the photocatalyst (11). It will also be understood that in the instance that the H2O, hydrogen and oxygen is not physically separated, and does impede the photocatalyst (11) from receiving the directed radiation, the liquid, vapour or gaseous states of these may reflect or reduce the effect that the directed radiation has on the photocatalyst (11) to photocatalytically split H2O.

Referring still to any one of FIG. 1 to 5, 10 or 11, in one embodiment, the window (12) is constructed to receive radiation from the radiation source (200) comprising the spectrum of both the high energy component and the low energy component into the reaction vessel (10). That is to say, the window (12) may be of a translucent or transparent material, such as glass, capable of transmitting both the high energy component and low energy components of the spectrum of the radiation source. The material, from which the window (12) is manufactured, is preferably one that permits the photocatalyst (11) to absorb as much of the directed radiation as possible. In particular, the material from which the window (12) is manufactured is selected to be one that permits as much of the high energy component (UV comprising visible light) and the low energy component (IR) therethrough to the photocatalyst (11). It will be understood that the low energy component may not be received by the reaction vessel (10) via the window (12), the low energy component may be directly applied onto the vessel (10) to increase the temperature of H2O within the reaction vessel (10).

In any one of the above embodiments, the apparatus (100) in use receives radiation from the radiation source (200) via the window (12) into the reaction vessel (10) such that the radiation absorbing particles absorb the high energy component from the spectrum of the radiation source (200) for photocatalytically splitting H2O within the reaction vessel (10). That is to say, in use, H2O is received or injected at the inlet (13) of the reaction vessel (10) and radiation of the radiation source (200) is directed onto the window (12) such that the high energy component of the spectrum of the radiation source (200) is utilised for photocatalytically splitting H2O.

In any one of the above embodiments, the apparatus (100) in use receives radiation from the radiation source (200) via the window (12) into the reaction vessel (10) such that the low energy component from the spectrum of the radiation source (200) increases the temperature of the H2O being photocatalytically split. That is to say, in use, H2O is received or injected at the inlet (13) of the reaction vessel (10) and the radiation of the radiation source (200) is directed onto the window (12), such that the window (12) is able to transfer or transmit the low energy component of the spectrum of the radiation source (200) to the H2O so as to increase the temperature thereof. It will be appreciated that the window (12) is selected such that it is able to transfer or transmit the low energy component of the spectrum to the H2O within the reaction vessel (10). In an alternative, the low energy component of the spectrum of the radiation source (200) may be directly applied onto the reaction vessel (10), such that the vessel (10) is able to transfer or transmit the low energy component of the spectrum to increase the temperature of H2O within the reaction vessel (10).

Also in this embodiment, in use, the low energy component of the spectrum of the radiation source (200) advantageously increases a rate at which the H2O is photocatalytically split by the radiation absorbing particles. That is to say, by utilising the entire spectrum of both the high energy and low energy components of the spectrum of the radiation source (200), the apparatus (100) is able to utilise the high energy component to photocatalytically split H2O and advantageously increase the rate at which the H2O is split by utilising the low energy component. In this way, the entire spectrum is used and advantageously the rate of the photocatalytic reaction is increased thus the apparatus (100) is able to increase H2 and O2 production utilising the low energy component of the radiation source (200) spectrum.

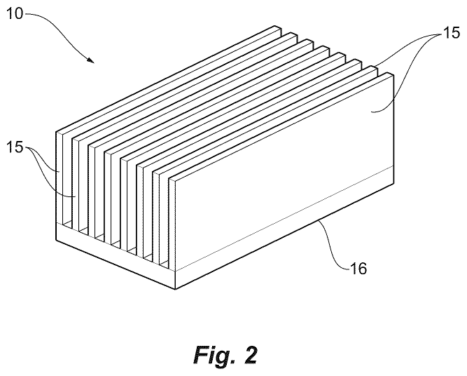

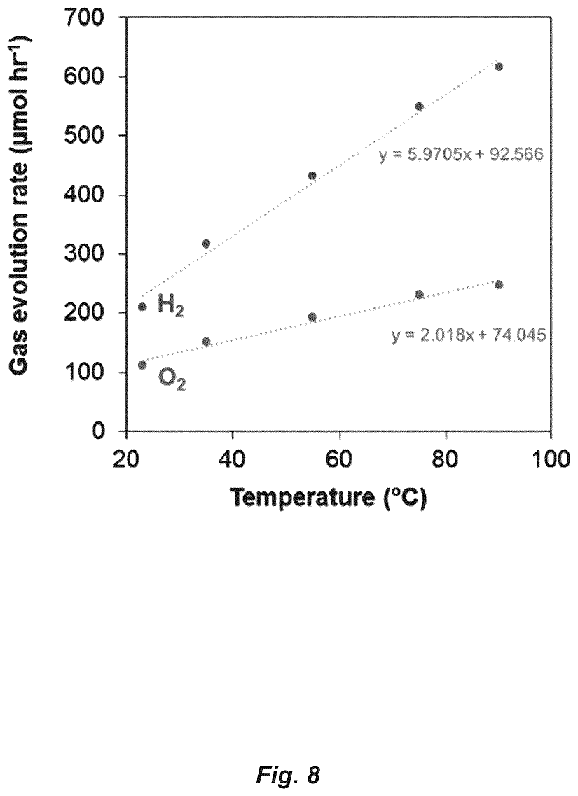

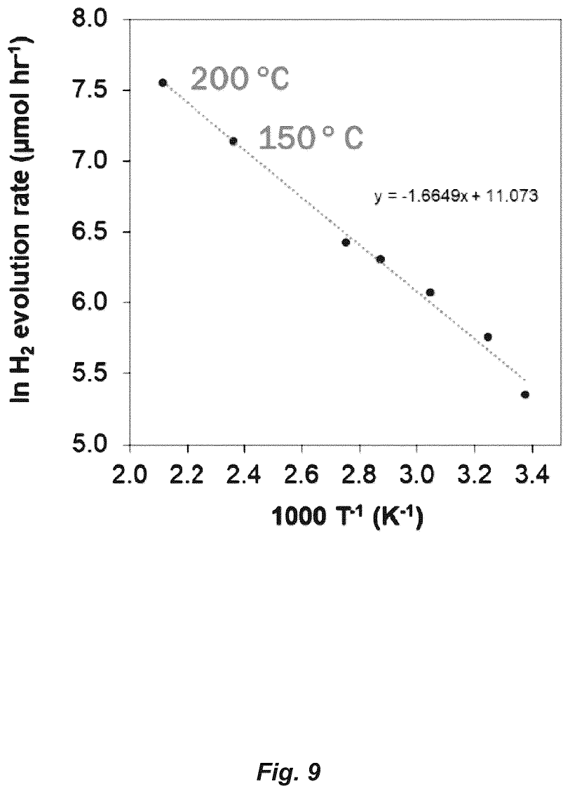

In one embodiment, referring now to FIGS. 8, 9 and 12, there are graphically illustrated the effects of increasing the temperature of H2O being photocatalytically split by the apparatus (100). Referring first to FIG. 8, which illustrates graphically the H2 and O2 gas evolution rates with increasing temperature. Based on laboratory testing and experimental data, the apparatus (100) has demonstrated that the produced chemical fuel (gas) is approximately 2:1 H2:02. FIG. 8 illustrates that H2 and O2 production rate (gas evolution rate, μmole/hr) as a function of temperature (i.e. the gradient of total production of gas vs temperature). Laboratory testing of the apparatus (100), as illustrated by FIG. 2, demonstrates that H2 evolution (i.e. H2 production rate of the apparatus (100)) at 90° C. is approximately 3 times greater than at 23° C. That is to say, by utilizing the low energy component of the spectrum and increasing the temperature of H2O being photocatalytically split the apparatus (100) advantageously is able to increase H2 production. Referring to FIG. 9, data points labelled 150° C. and 200° C. are extrapolations of apparatus (100) experimental data illustrating a linear relationship exists shown by extrapolation.

In FIGS. 8 and 9, H2 evolution rate in μmole/hr is plotted as a function of 1000/temperature in Kelvin to illustrate the linear dependence of H2 evolution vs temperature with no drop off noticeable with increasing temperatures. This temperature dependence of chemical reaction rates may, for example, follow the Arrhenius equation:

k=Ae^{-E}^{ₐ}^{/RT}

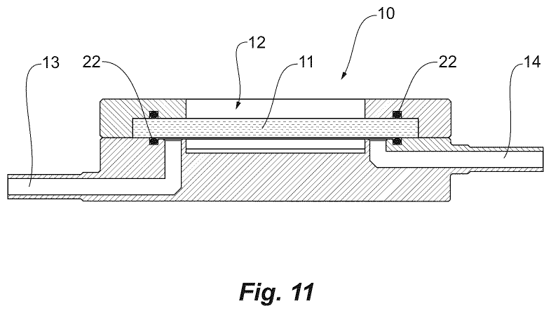

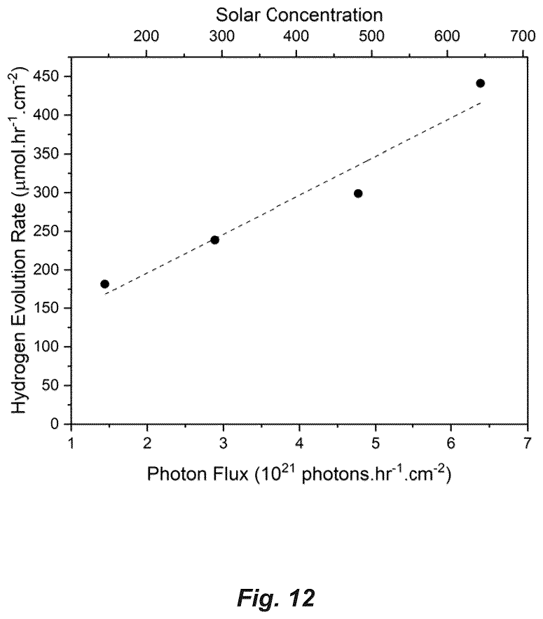

FIGS. 11 and 12 illustrate that plotting in k vs 1000/T gives a straight line with slope equal to −Eₐ/R. Where; k is the rate constant, A is the pre-exponential factor, Eₐ is the activation energy, R is the universal gas constant (8.314 J K⁻¹ mol⁻¹) and T is the absolute temperature in Kelvin. Referring particularly to FIG. 9, assuming the Arrhenius behaviour holds, a projection of H2 production at increasing temperatures can be made. FIG. 9 illustrates that projection of the linear line at a constant slope would give H2 production of 6 times greater at 150° C., and 9 times greater at 200° C. when compared to H2 production at 23° ° C.

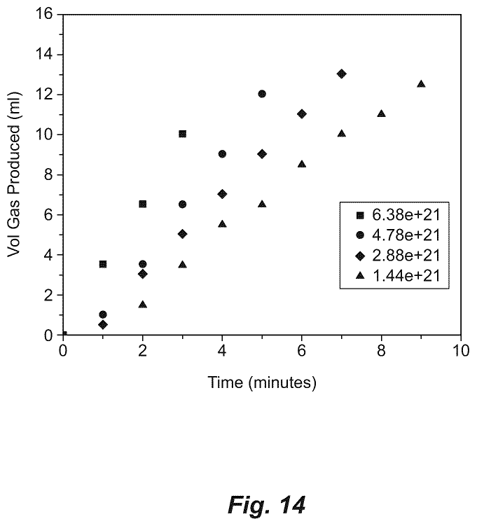

In FIG. 12, Hydrogen (H2) evolution rate is graphically represented as a function of Solar Concentration resultant of H2O being photocatalytically split by the apparatus (100). Based on laboratory testing and experimental data, the apparatus (100) has demonstrated that the response of photocatalyst (11) with increased directed radiation (200) (i.e. Solar Concentration on FIG. 12) advantageously provides a linear relationship. In FIG. 14, Hydrogen (labelled ‘Vol Gas produced’ on the Y-axis) production rate is graphically represented as a function of time in minutes, illustrating the effects of increasing photon flux (or directed radiation intensity). In this Figure, there is represented the photocatalyst (11) of any one of the embodiments described herein, and based on laboratory testing and experimental data, it is demonstrated that the photocatalyst (11) produces increasing volume of hydrogen with increased radiation intensity.

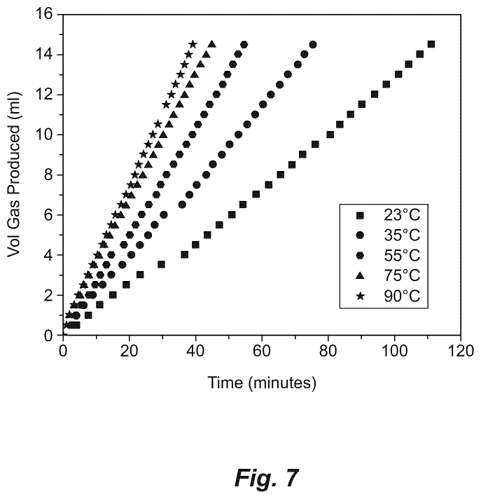

In one embodiment, referring to any one of the Figures, the radiation absorbing particles of the photocatalyst (11) may comprise one or more of micro-particles, nano-particles or pico-particles capable of absorbing thermal radiation to photocatalytically split H2O. In an alternative embodiment, the radiation absorbing particles of the photocatalyst (11) may be an aluminium doped SrTiO₃ photocatalyst. In one example of this alternate embodiment, the photocatalyst (11) may be a semiconductor. In another example of this alternate embodiment, the photocatalyst (11) may be a radiation absorbing material. This photocatalyst has an apparent quantum yield of approximately 50% at 365 nm, and when solar radiation is the radiation source (200), this photocatalyst has an overall Solar to Hydrogen (“STH”) of ˜0.4%. With particular reference to FIG. 7, there is graphically illustrated the apparatus (100) in use with a 50% UV-ATA LED as the radiation source (200). In this Figure, the 50% UV-ATA LED is 365 nm at 55 mW/cm² of maximum output, equivalent of up to 11 Suns (i.e. 11× the UV output as the high energy component and 11× the IR output as the low energy component of the sun), and the H2O injected or received at the inlet (13) is in a liquid phase. FIG. 7 illustrates the total H2 and O2 (gas volume) produced over time (reaction time) at varying temperatures within the reaction vessel (10) (the temperature being varied by increasing the temperature of the oven in which the reaction vessel is located). It is notable from the Figure that H2 production per time increases as temperature is increased within the reaction vessel (10), thus by utilising the low energy component of the spectrum of the radiation source (200), the H2 production is increased. It will be appreciated that the radiation absorbing particles of the photocatalyst (11) (as the photocatalyst) is not the focus of this invention, and may be an alternative photocatalyst not discussed herein such that it is one that is able to photocatalytically split H2O into H2 and O2 while being able to operate under varied temperature conditions.

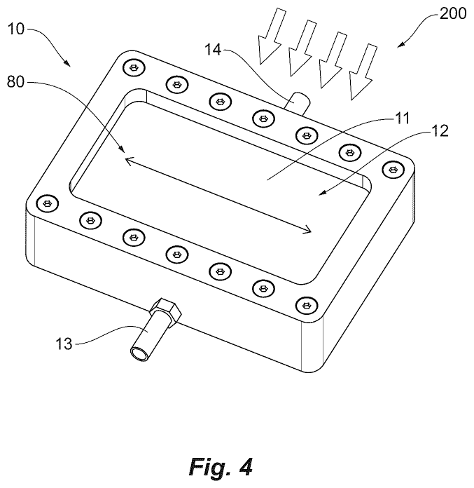

In any one of the above embodiments, with particular reference to FIGS. 1 and 4, the window (12) of the reaction vessel (10) is elongate, and the direction of elongation, indicted by arrows (80), is perpendicular to a flow path of the H2O from the inlet (13) to the outlet (14). The elongate window (12) has a length of elongation that is greater than a length of the flow path of H2O, whereby the length of the flow path of H2O is from the inlet (13) to the outlet (14).

In this particular arrangement, the photocatalyst (11) may also be elongate and extend in the same direction as the elongate window (12). This arrangement maximises a surface area of both the window (12) and the photocatalyst (11) to allow directed radiation thereupon, while minimising the temperature increase experienced by the H2O as it flows from the inlet (13) to the outlet (14). That is to say, the dimensions of the elongate window (12) relative to the length of the H2O flow path is designed to minimise the temperature increase experienced by the H2O as it flows from the inlet (13) to the outlet (14).

Additionally, the radiation concentrator assembly (20) extends in a longitudinal direction that is parallel to the elongate direction of both the window (12) and the photocatalyst (11). Accordingly, the longitudinal direction that the radiation concentrator assembly (20) extends is perpendicular to the H2O flow path.

The temperature increase experienced by the H2O as it flows from the inlet (13) to the outlet (14) is aided, in that no unexpected localised temperature fluctuations within the flow path are experienced, by virtue of the feature that the H2O is directed through the reaction vessel (10) such that the photocatalytically split hydrogen and oxygen does not impede the radiation absorbed by the photocatalyst (11) via the window (12).

The present inventors have surprisingly found that it is particularly advantageous to the presented process of photocatalytically splitting H2O into hydrogen and oxygen to minimise the temperature increase experienced by the H2O as it flows from the inlet (14) to the outlet (14), by constructing the reaction vessel (10) with the elongate window (12) having a length of elongation that is greater than a length of the flow path of H2O, and by arranging the radiation concentrator assembly (20) to extend in a longitudinal direction that is parallel to the elongate direction of the window (12).

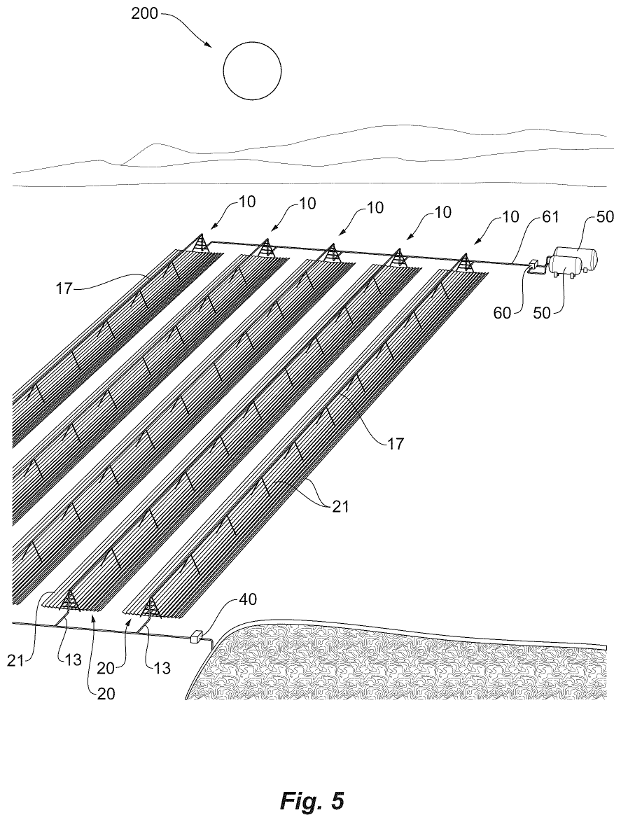

Referring now to FIG. 5, in one embodiment, the radiation concentrator assembly (20) comprises a plurality of optical elements (21), where each of the optical elements (21) comprise one or more reflectors for reflecting and concentrating radiation from the radiation source (200). That is to say, the one or more reflectors are capable of reflecting and concentrating both the low energy (IR, comprising at least partially visible light) and high energy (UV comprising visible light) components of the radiation source (200), onto the window (12) of the reaction vessel (10) so as to photocatalytically split H2O via the photocatalyst (11) and to concurrently increase H2O temperature. In this embodiment, the optical elements (21) are positionable and adjustable so as to be able to track the radiation source (200). It will be understood that in the instance that the radiation source (200) is the Sun, the optical elements (21) are positionable and adjustable so as to be able to track the Sun during daylight hours to maximise/maintain/control solar radiation directed onto the window (12) of the reaction vessel (10) and photocatalytically split H2O.

In an alternative embodiment to the above, the radiation concentrator assembly (20) may comprise the plurality of optical elements (21), where each of the optical elements (21) comprise one or more refractors (not shown) to refract and concentrate radiation from the radiation source (200). That is to say, in this alternative embodiment, the one or more refractors refract and concentrate both the high energy and low energy components of the radiation source. Additionally, in this alternative embodiment, the one or more refractors are one or more converging lenses. It will be appreciated, although not shown in the Figures, that the plurality of optical elements (21) may comprise both reflectors and refractors for reflecting and refracting radiation from the radiation source (200).

Still referring to FIG. 5, in one embodiment of the radiation concentrator assembly (20), the optical elements (21) are Linear Fresnel Reflectors (LFRs) that are known for their use in concentrating and directing solar radiation (as the Sun would be the radiation source (200) in this instance). As illustrated in the Figures, the LFRs comprise an array of optical elements (21) that are typically parabolic troughs capable of concentrating and directing solar radiation from the Sun (200) best shown in FIG. 8. In an alternative, not illustrated, the LFRs may comprise an array of optical elements that are flat (linear) mirrors that are capable of concentrating and directing solar radiation from the Sun (200). In either embodiments, the window (12) of the reaction vessel (10) is elongate and the LFRs direct radiation from the radiation source (200) along an elongate length of the window (17). The window (12) being elongate and the optical elements (21) may either comprise a concave shape or be flat (linear) in shape (not illustrated) for directing the radiation from the radiation source along the elongate length of the window (17). It will be appreciated that the optical elements (21) of the LFR are particularly capable of directing and transmitting the full spectrum comprising both high energy and low energy components of the radiation source (200) to the elongate window (17), such that the high energy component comprising visible light is used for photocatalytically splitting H2O and the low energy component is used to increase the temperature of the H2O being photocatalytically split.

In the above embodiment, wherein the radiation concentrator assembly (20) are Linear Fresnel Reflectors (LFRs), it will be appreciated that there is an advantage in that the window (12) of the reaction vessel (10) is not required to move in the instance that the Sun is the radiation source (200). But rather it is the LFRs that track the radiation source (200), the Sun, across the sky. In this way, the inlet (13) and outlet (14) of the reaction vessel (10) may advantageously be fixed, as the vessel (10) remains stationary when receiving the directed radiation from the LFRs.

In the above embodiments, the LFR optical elements (21) of the radiation concentrator assembly (20) are positioned and adjusted so as to maximize radiation of the radiation source (200) and the spectrum comprising both high energy and low energy components directed onto the window (12) of the reaction vessel (10). The reaction vessel (10) may be located above the array of LFR optical elements (21), best illustrated by FIG. 5, of the radiation concentrator assembly (20), and the optical elements (21) are positioned and adjusted such that radiation from the radiation source (200) is directed onto the window (12). In this embodiment, the reaction vessel (10) may comprise a body with a trapezoidal cavity receiver (not illustrated) with the window (12) positioned within the trapezoidal cavity to which the radiation from the radiation source (200) is directed onto.

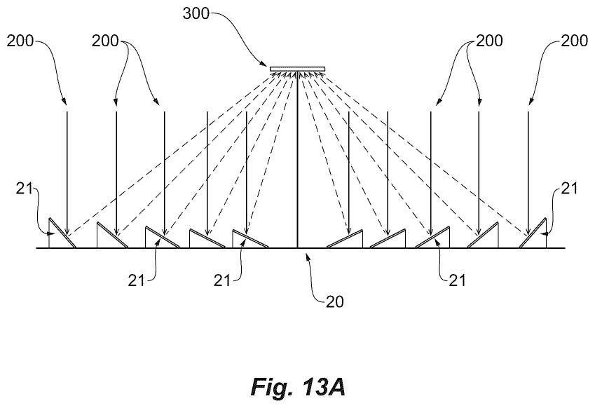

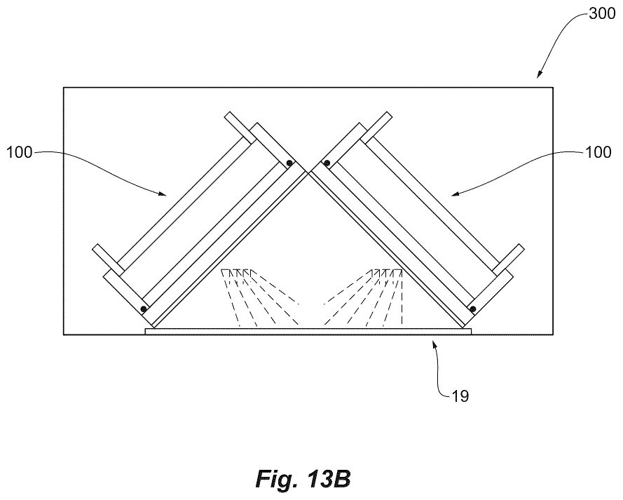

Referring now to FIGS. 13A and 13B, there is illustrated an alternative embodiment of the radiation concentrator assembly (20) comprising a plurality of optical elements (21), wherein the radiation concentrator assembly (20) is arranged on a horizontal surface (which may be a flat horizontal landscape). In this alternative embodiment, one or more reaction vessels (10) may be combined to form a receiver (300), whereby the one or more reaction vessels (10) are not parallel to the horizontal surface, and are at an angle to the horizontal surface. As illustrated in FIG. 13B, two reaction vessels (10) at an angle to the horizontal surface to form a triangular prism between the elongate windows (12) of each vessel (10), and a surface (310) of the receiver (300). The surface (310) of the receiver (300) being particularly designed to allow directed radiation from the radiation concentrator assembly (20) to pass therethrough and onto each elongate window (12) of each vessel (10). In this arrangement, the surface (310) and the receiver (300) are elongate, whereby the elongate direction is in the same direction as the elongate window (12) described in an earlier embodiment. Within the triangular prism formed between the elongate windows (12) and the surface (310), there is an air cavity. In this alternative embodiment, by being at an angle to the horizontal, when H2O is photocatalytically split into hydrogen and oxygen in each reaction vessel (10), advantageously the produced hydrogen and oxygen gases rapidly flow to respective outlets (14) from respective photocatalysts (11).

Referring again to FIG. 5, there is illustrated an example of a plurality of apparatus (100) in a field utilising LFR optical elements (21) as the corresponding radiation concentrator assemblies (20) for each reaction vessel (10) to photocatalytically split H2O using the Sun as the radiation source (200). In this embodiment, H2O may be sourced from a reservoir (30) and pumped via a pump (40) to the inlet (13) of each apparatus (100) to be photocatalytically split into the chemical fuels H2 and O2 which is subsequently discharged at the corresponding outlet (14) and stored within corresponding H2 and O2 storage facilities (50). The stored H2 and O2 within storage facilities (50) may then subsequently be used as chemical fuels for energy production as required. In this way, the apparatus (100) is able to photocatalytically split H2O into H2 and O2 as chemical fuels that are easily captured and stored within facilities like (50), and is advantageously scalable as illustrated in FIG. 5 to maximise the use of the radiation source (200) utilising its entire spectrum for creating the chemical fuels. It will be appreciated that in this embodiment of FIG. 5, the radiation source (200) is ideally the Sun, and the entire solar spectrum comprising both IR (which may at least partially comprise visible light) and UV (comprising visible light) is utilised by the apparatus (100) to photocatalytically split H2O.

In any one of the above embodiments employing the LFRs as the optical elements (21) of the radiation concentrator assembly (20), in the scenario where the radiation source (200) is the Sun, the radiation concentrator assembly (20) reflects and concentrates solar radiation from the Sun such that the window (12) receives the full solar spectrum of both high energy and low energy to photocatalytically split H2O within the reaction vessel (10). An advantage of the radiation concentrator assembly (20) in this embodiment is its ability to amplify the solar radiation from the Sun, such that the reflected (or directed) solar spectrum received by the window (12) comprises both high energy (UV comprising visible light) and low energy (IR, which may at least partially comprise visible light) components greater than that of one Sun (i.e. amplified such that the UV and IR components of the solar spectrum greater than that of the Sun directly onto the window). It will be appreciated that the apparatus (100) disclosed herein, as illustrated by FIG. 5, may advantageously be integrated into existing LFR systems such as those illustrated for concentrating solar radiation.

In any one of the above embodiments, the apparatus (100) may further comprise a separator (60) for separating H2 from O2. The separator (60) being located downstream of the outlet (14) of the reaction vessel (10) and being connected thereto via a conduit (61). It will be appreciated that the separator (60) is in fluid communication with the outlet (14) of the reaction vessel (14), and may comprise an H2 outlet (not shown) and an O2 outlet (not shown), whereby each H2 and O2 outlet is in fluid communication with a respective H2 or O2 storage facility (50).

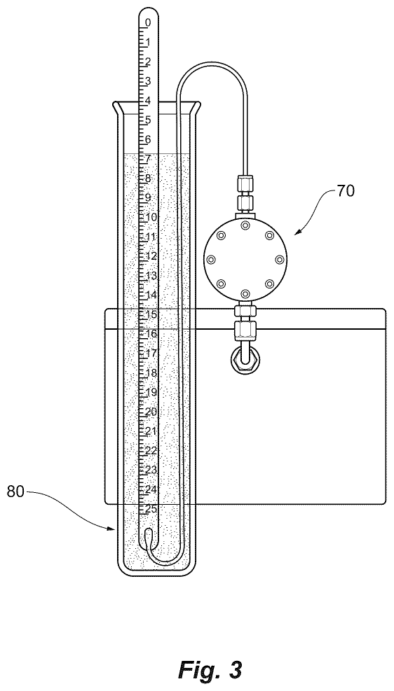

In any one of the above embodiments, the reaction vessel (10) may be pressurised. That is to say, the H2O received at the inlet (13) of the reaction vessel (10) is pressurised so as to flow the H2O from the inlet (13), allowing H2O to be photocatalytically split by the radiation absorbing particles of the photocatalyst (11) which is exposed to both high energy and low energy components of the radiation source (200) received via the window (12), and subsequently the H2 and O2 chemical fuels are discharged through the outlet (14) of the reaction vessel (10). In this embodiment, referring to FIG. 3, the reaction vessel may be pressurised by a back-pressure regulator (70) in fluid communication with the inlet (13) of the reaction vessel (10).

In the above embodiment, the reaction vessel may also comprise a eudiometer (80) shown in FIG. 3. Whereby the eudiometer (80) is used to measure H2 and O2 volumes produced at the outlet (14) of the reaction vessel (10) by measuring the change in volume of the H2/O2 mixture at the outlet (14). In this way, the eudiometer (80) in fluid communication with the outlet (14) of the reaction vessel (10) is able to monitor the ratio of H2 to O2 produced.

In any one of the above embodiments, the H2O injected or received at the inlet (13) of the reaction vessel (10) or apparatus (100) is in either a liquid or gas phase, or both. It will be appreciated that ideally the H2O injected or received at the inlet (13) to be photocatalytically split is clean water, however in an alternative embodiment, “dirty water” (such as waste water or water by-products of other processes) may be utilised by the apparatus (100) or method of any one of the above embodiments to produce H2. In this alternative embodiment, the “dirty water” is used in place as H2O injected or received at the inlet (13) may be in either a liquid or gas phase, or both. Also in this alternative embodiment, if the “dirty water” is in the gas phase, it may have been distilled in order to be in the gas phase. Additionally, distilling of the “dirty water” may be performed within the apparatus (100) during exposure to the low energy component of the radiation source (200). It will be appreciated that the distillation of the “dirty water” in effect purifies the water and separates any impurities from the H2 and O2 produced.

It should be apparent from any one of the above embodiments disclosing the apparatus (100) or the method ideally intends to use solar energy as the radiation source (200) to photocatalytically split H2O to produce H2. Solar energy is freely and endlessly available clean source of energy which can assist to meet present and future energy needs. Thus, a key advantage of the apparatus (100) and method disclosed in any one of the above embodiments is to harness this energy by photocatalytically splitting H2O to produce usable and storable hydrogen (H2) as the form of chemical fuel. An additional advantage of the apparatus (100) and method disclosed in any one of the above embodiments is that O2 (i.e. oxygen) is also produced by photocatalytically splitting H2O, which may also be used as a chemical fuel for other energy or chemical production needs.

In any one of the above embodiments, it will also be apparent that the apparatus (100) co-produces H2 and O2 by photocatalytically splitting H2O, both H2 and O2 react exothermically to release energy. The auto-ignition temperature of a 2:1 stoichiometric mixture of H2 to O2 is 570° C., which will be appreciated as a “maximum temperature” for the apparatus (100) to operate at to photocatalytically split H2O, and be an upper limit to which the low energy (IR) component of the spectrum of the radiation source (200) is applied onto the window (12) of the reaction vessel (10) such that the temperature of the H2O is below this auto-ignition temperature of 570° C. In the scenario where H2O is in gas or vapour phase within the reaction vessel (10), there is a mixture of both H2 and O2 present within the reaction vessel (10), which increases the auto-ignition temperature above 570° C. That is to say, advantageously, the presence of H2 and O2 within the reaction vessel (10), effectively suppresses the auto-ignition process.

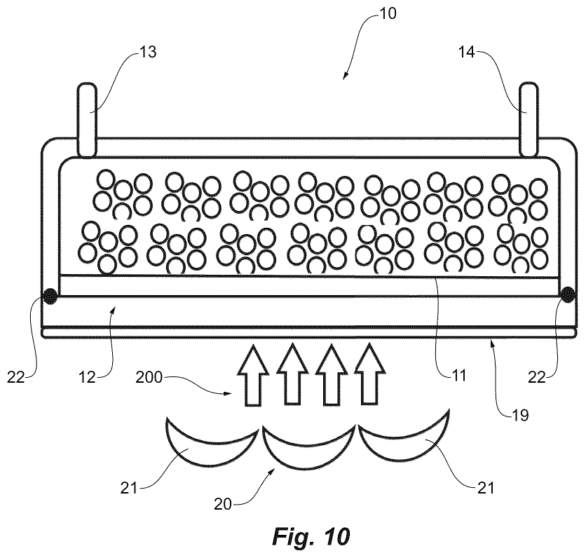

In any one of the above embodiments, best illustrated by FIG. 10, the window (12) comprises an external surface that may be coated with one or more coatings (19) such as an infrared (IR) reflective coating or an upconversion coating. The one or more coatings on the external surface of the window (12) may serve a number of purposes, such as but not limited to, providing a thermally insulating layer to assist in protecting the window (12) against high temperatures from the directed radiation, assist in providing the window (12) with shatterproof properties, or assist in providing the window (12) with properties that assist in amplifying or improving the directed radiation thereonto.

In one example, wherein the external surface of the window (12) comprises the infrared (IR) reflective coating (19), the IR reflective coating acts so as to reduce a temperature within the reaction vessel (10) by being an insulating layer. In this example, the IR reflective coating may additionally assist in increasing the longevity of the window (12), the photocatalyst (11) and other components of the reaction vessel (10) that may be subject to wear from high temperatures imparted by the directed radiation. Furthermore, in this example, the use of the IR reflective coating may be to assist in keeping the temperature within the reaction vessel (10) below the auto-ignition temperature of 570° ° C. of the H2 and O2, while permitting the use of higher high energy component (UV comprising visible light) from the radiation source (200).

In another example, wherein the external surface of the window (12) comprises an upconversion coating (19), the upconversion coating acts so as to convert long-wavelengths from the directed radiation into short-wavelengths when radiation is directed onto the window (12). In this example, by converting long-wavelengths of the directed radiation into short-wavelengths, the upconversion coating advantageously improves the efficiency of the photocatalyst (11) in its ability to photocatalytically split H2O into hydrogen and oxygen. Additionally, in this example, the upconversion coating additionally converts visible photons into ultraviolet (UV) photons.

In one embodiment, referring now to FIG. 2, to assist in maintaining temperature within the reaction vessel (10) and at the photocatalyst (11) below the auto-ignition temperature of 570° C. of the H2 and O2 chemical fuel products, the reaction vessel (10) may further comprise one or more cooling fins (15) extending outwardly from a rear (16) or a side (not shown) of the reaction vessel (10). The one or more cooling fins (15), as illustrated in FIG. 2, may extend perpendicularly and outwardly from the rear (16) of the reaction vessel (10) and be spaced apart from the adjacent cooling fin (15) so as to disperse temperature within the reaction vessel (10). Advantageously, the inclusion of the one or more cooling fins (15) act so as to reduce the temperature within the reaction vessel (10), such that the low energy component (IR) from the radiation source (200) may be higher without the temperature within the reaction vessel (10) reaching the auto-ignition temperature of 570° C. of the H2 and O2, while permitting the use of higher high energy component (UV comprising visible light) from the radiation source (200). It will be appreciated that the use of one or more cooling fins (15) to reduce the temperature within the reaction vessel (10) is a passive cooling function to the reaction vessel (10). In this embodiment, not illustrated, it will be appreciated that the one or more cooling fins (15) and the infrared (IR) coating applied to the external surface of the window (12) may, in combination, act so as to further reduce the temperature within the reaction vessel (10).

In another embodiment, not illustrated in the Figures, the reaction vessel (10) may be enclosed by a jacket (not shown), where the jacket comprises one or more injection ports and one or more corresponding ejection ports so as to enable a cooling fluid to flow through the jacket to cool the reaction vessel (10). In this way, the jacket acts so as to reduce a temperature within the reaction vessel (10) in an active manner. Similar to the above embodiments and examples, the jacket assists to keep the temperature within the reaction vessel (10) below the auto-ignition temperature of 570° C. of the H2 and O2, while permitting the use of higher high energy component (UV comprising visible light) from the radiation source (200). The cooling fluid, when the jacket is in use, is heated by the reaction vessel (10), is directed downstream of the one or more ejection ports and may subsequently be used as a heated fluid by-product (e.g. for a Stirling engine, other processes that utilise heated fluids for energy generation, or simply be used as a heated fluid required by a plant). In this way, it will be appreciated that the heated cooling fluid downstream of the one or more ejection ports may serve as an additional fuel resultant of the apparatus (100).

In an alternative embodiment, best illustrated by FIG. 10, the window (12) is located on an underside of the reaction vessel (10). In this arrangement, the at least one optical element (21) of the radiation concentrator assembly (20) is configured so as to direct radiation onto the window (12) from the underside of the reaction vessel (10). In this embodiment, the reaction vessel (10) may be considered an inverted or up-side-down vessel (10), defined by the underside location of the window (12) and receiving the directed radiation from the same underside. In this embodiment, illustrated by FIG. 10, the photocatalyst (11) is adjacent to the window (12) such that the H2O and the subsequent hydrogen and oxygen photocatalytically split therefrom, is physically separated from the window (12) by the photocatalyst (11). In this embodiment, advantageously, the H2O, the hydrogen or the oxygen do not impede the radiation absorbed by the photocatalyst (11) via the window (12). Accordingly, in this embodiment, any liquid, vapour or gaseous phases do not reflect/deflect/obstruct/reduce the directed radiation onto the photocatalyst (11). In this embodiment, the external surface of the window (12) is on the underside of the reaction vessel (10), and it may be coated with one or more of the infrared (IR) reflective coating or the upconversion coating (19).

In any one of the above embodiments, the reaction vessel (10) may further comprise a seal (22) disposed between the window (12) and a body of the reaction vessel. The seal (22) being particularly designed so as to prevent the loss of H2O, hydrogen or oxygen from the reaction vessel (10). The seal (22) may be an o-ring seal, or another elastic seal capable of preventing the loss of H2O, hydrogen or oxygen. The seal (22) may also comprise properties that contain or maintain a temperature (or temperature gradient) within the reaction vessel (10).

In addition to the apparatus (100) discussed in any one of the above embodiments, an exemplary method for photocatalytically splitting H2O using the radiation source (200) may comprise the steps of:
a) Flowing H2O through the inlet (13) of the reaction vessel (10), of any one of the above embodiments, comprising the photocatalyst (11) comprising radiation absorbing particles positioned between the inlet (13) and the outlet (14) of the reaction vessel (10);
b) Using the radiation concentrator assembly (20), of any one of the above embodiments, to concentrate radiation comprising the spectrum comprising a high energy (UV comprising visible light) component and a low energy (IR, which may at least partially comprising visible light) component from the radiation source (200) and directing the concentrated radiation onto an elongate window (12) extending in a direction perpendicular to the flow path of the H2O of the reaction vessel (10);
c) Exposing both the H2O and the photocatalyst (11) to the concentrated radiation through the elongate window (12), such that the radiation absorbing particles absorb the high energy (UV comprising visible light) component of the spectrum to photocatalytically split the H2O into H2 and O2, and the low energy (IR, which may at least partially comprising visible light) component of the spectrum increases the temperature of the H2O within the reaction vessel (10);
d) Discharging the resultant H2 and O2 via the outlet (14) of the reaction vessel; and
e) Subsequently, separating the discharged H2 from the O2 in the separator (60), which is in fluid communication with the outlet (14), and storing the H2 and O2 in respective storage facilities (50).

In the above method, it will be appreciated that ideally the radiation source (200) utilised is the Sun, and the radiation is solar radiation and the spectrum is the solar spectrum comprising both UV comprising visible light and IR components. Also in this method, the radiation concentrator assembly (20), in use, amplifies the solar radiation from the sun such that the reflected spectrum received by the window (12) comprises both high energy (UV comprising visible light) and low energy (IR) components greater than that of the Sun (or one Sun). It will be understood from the above method and the embodiments of the apparatus (100), that there is provided a scalable, storable and renewable energy solution by photocatalytically splitting H2O into H2 and O2 chemical fuels by utilising both high energy (UV comprising visible light) and low energy (IR, which may at least partially comprising visible light) components of the solar spectrum. A key advantage of the method and apparatus (100) disclosed is that there are no other by-products of photocatalytically splitting H2O for H2 and O2 production.

In any one of the above embodiments of the apparatus (100) or method, it will be appreciated that the disclosure photocatalytically splits H2O using the radiation source (200) to produce hydrogen and oxygen in a continuous manner. That is to say, in contradistinction from existing manners of hydrogen production that are generally ‘batch production’ methods, the present disclosure allows for the continuous flow of H2O into the reaction vessel (10) via the inlet (13) and subsequent discharge of the resultant H2 and O2 via the outlet (14), provided that the radiation source (200) is available to be directed and concentrated onto the window (12) of the reaction vessel (10). In this way, the present disclosure provides for an apparatus (100) and method that is a scalable, storable and renewable energy solution for producing H2 and O2 chemical fuels.

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1. An apparatus for photocatalytically splitting H2O using a radiation source, the apparatus comprising:
a reaction vessel for receiving H2O to be split photocatalytically; and
a radiation concentrator assembly,
wherein the reaction vessel comprises:
a window for receiving radiation from the radiation source into the reaction vessel;
an inlet for receiving H2O into the reaction vessel;
a photocatalyst positioned within the reaction vessel comprising radiation absorbing particles such that, in use, the radiation absorbing particles absorb radiation and photocatalytically split the H2O into hydrogen and oxygen;
an outlet for discharging the hydrogen and oxygen from the reaction vessel; and
wherein the radiation concentrator assembly comprises:
at least one optical element arranged and constructed to direct radiation onto the window.

2. The apparatus of claim 1, wherein the window is elongate and the direction of elongation is perpendicular to a flow path of the H2O from the inlet to the outlet.

3. The apparatus of claim 2, wherein the photocatalyst is elongate in the same direction as the elongate window, and the radiation concentrator assembly extends in a longitudinal direction parallel to the elongate direction of the window and perpendicular to the H2O flow path.

4. The apparatus of claim 1, wherein the H2O and photocatalytically split hydrogen and oxygen is separated from the window by the photocatalyst.

5. The apparatus of claim 1, wherein, in use, the H2O is directed through the reaction vessel such that the photocatalytically split hydrogen and oxygen does not impede the radiation absorbed by the photocatalyst via the window.

6. The apparatus of claim 1, wherein the window is located on an underside of the reaction vessel, and the at least one optical element is arranged to direct radiation onto the window from the underside of the reaction vessel.

7. The apparatus of claim 1, wherein the window comprises an external surface that is coated with an infrared (IR) reflective coating, wherein in use, the infrared (IR) reflective coating acts so as to reduce a temperature within the reaction vessel.

8. The apparatus of claim 1, wherein the window comprises an external surface that is coated with an upconversion coating that acts so as convert long-wavelengths from the directed radiation into short-wavelengths.

9. (canceled)

10. The apparatus of claim 7, wherein the reaction vessel further comprises one or more fins extending outwardly from a rear or a side of the reaction vessel, wherein in use, the one or more fins and the infrared (IR) reflective coating act so as to reduce a temperature within the reaction vessel.

11. The apparatus of claim 1, wherein the radiation source comprises a spectrum comprised of both a high energy component and a low energy component.

12. The apparatus of claim 10, wherein the radiation source is solar radiation and the spectrum comprises the entire solar spectrum of both an ultraviolet (UV) component comprising visible light and an infrared (IR) component comprising at least partially visible light of the solar spectrum.

13. (canceled)

14. The apparatus of claim 11, wherein the window is constructed to receive radiation from the radiation source comprising the spectrum of both the high energy component and the low energy component into the reaction vessel.

15. The apparatus of claim 12, wherein in use, the radiation absorbing particles absorb the high energy component of the spectrum for photocatalytically splitting H2O, and wherein the low energy component of the spectrum increases the temperature of the H2O being photocatalytically split.

16. (canceled)

17. The apparatus of claim 12, wherein in use, the low energy component of the spectrum increases a rate at which the H2O is photocatalytically split by the radiation absorbing particles.

18. The apparatus of claim 1, wherein the radiation concentrator assembly comprises a plurality of optical elements, wherein each of the optical elements comprise one or more reflectors for reflecting and concentrating radiation from the radiation source.

19. The apparatus of claim 15, wherein the one or more reflectors are Linear Fresnel Reflectors (LFRs) that reflect and concentrate both the high energy and low energy components of the radiation source.

20. (canceled)

21. (canceled)

22. The apparatus of claim 15, wherein the optical elements are parabolic troughs that are positionable and adjustable so as to track the radiation source, the parabolic troughs comprise a concave shape for directing radiation from the radiation source along an elongate length of the window, and wherein in use, the optical elements of the radiation concentrator assembly are positioned and adjusted so as to maximize radiation of the radiation source and the spectrum comprising both high energy and low energy components directed onto the window.

23. (canceled)

24. (canceled)

25. (canceled)

26. The apparatus of claim 1, wherein the reaction vessel is enclosed by a jacket, wherein the jacket comprises one or more injection ports and one or more corresponding ejection ports so as to enable a cooling fluid to flow through the jacket to cool the reaction vessel, wherein in use, the cooling fluid is heated by the reaction vessel and is directed downstream of the one or more ejection ports for use as a heated fluid by-product.

27. (canceled)

28. An apparatus for photocatalytically splitting H2O using a radiation source, the apparatus comprising:
a reaction vessel; and
a radiation concentrator assembly,
wherein the reaction vessel comprises:
an inlet for receiving H2O into the reaction vessel;
a photocatalyst positioned within the reaction vessel comprising radiation absorbing particles such that, in use, the radiation absorbing particles absorb radiation and photocatalytically split the H2O into hydrogen and oxygen;
an outlet for discharging the hydrogen and oxygen from the reaction vessel;
a window that is elongate in a direction perpendicular to a flow path of the H2O from the inlet to the outlet, wherein the elongate window receives radiation from the radiation source and into the reaction vessel; and
wherein the radiation concentrator assembly extends in a longitudinal direction parallel to the elongate direction of the window and comprises:
at least one optical element arranged and constructed to direct radiation onto the elongate window.

29. A method for photocatalytically splitting H2O using a radiation source, the method comprising the steps of:
(a) flowing H2O through an inlet of a reaction vessel comprising a photocatalyst comprising radiation absorbing particles positioned within the reaction vessel;
(b) using a radiation concentrator assembly to concentrate radiation comprising a spectrum comprising a high energy component and a low energy component from the radiation source and directing the concentrated radiation onto an elongate window extending in a direction perpendicular to a flow path of the H2O in the reaction vessel;
(c) exposing both the H2O and the photocatalyst to the concentrated radiation through the elongate window, such that the radiation absorbing particles absorb the high energy component of the spectrum to photocatalytically split the H2O into hydrogen and oxygen, and the low energy component of the spectrum increases the temperature of the H2O within the reaction vessel; and
(d) discharging the resultant hydrogen and oxygen via the outlet of the reaction vessel.
